(19) United States
(12) Patent Application Publication
(10) Pub. No.: US 2016/0224686 A1
(43) Pub. Date: Aug. 4, 2016

(54) SYSTEMS AND METHODS FOR SOCIAL MEDIA TREND PREDICTION

(71) Applicant: AVIGILON FORTRESS CORPORATION, Vancouver (CA)

(72) Inventor: Narayanan Ramanathan, Chantilly, VA (US)

(21) Appl. No.: 14/959,498

(22) Filed: Dec. 4, 2015

Related U.S. Application Data
(60) Provisional application No. 62/110,249, filed on Jan. 30, 2015.

(51) Int. Cl. G06F 17/30

(52) U.S. Cl. CPC G06F 17/30958; G06F 17/30864

(57) ABSTRACT

Embodiments relate to systems, devices, and computer-implemented methods for predicting social media trends by receiving multiple sets of social media data from a social media service, wherein each set of social media data includes multiple entries and each entry is associated with a user identifier. For each set of social media data: labels can be extracted; a social media data graph can be generated with nodes representing labels and user identifiers and edges representing a co-occurrence of labels or a co-occurrence of a label and a user identifier; and the social media data graph can be analyzed to determine a graph metric score for nodes corresponding to a label. The graph metric scores of a node across multiple sets of social media data can be used to predict that the label corresponding to the node will be significant to trending, e.g., will begin trending.

### CROSS-REFERENCE TO RELATED APPLICATIONS

This application claims priority to and the benefit of U.S. Provisional Patent Application No. 62/110,249, titled “HASHTAG TREND PREDICTION”, filed on 30 Jan. 2015, which is hereby incorporated by reference.

### BACKGROUND

Social media services are computer-mediated tools that allow people to create, share or exchange information, ideas, and pictures/videos in virtual communities and networks. Not only has social media revolutionized communication between businesses, organizations, communities, and individuals, but the user-generated content from social media has proven to be a vast resource for data mining. Indeed, analyses of social media data have numerous applications for individuals, as well as commercial, organizational, and administrative applications.

For example, social media websites, such as Facebook, Twitter, Google+, and Instagram, allow users to self-identify labels in their user-generated content using a hashtag. Users can simply prefix a word or un-spaced phrase with a hash character (#) to create a hashtag. The hashtag allows grouping of similarly tagged messages, and also allows an electronic search to return all messages that contain it.

Users generally use hashtags to express context of a given message. For example, attendees of a certain event may include a common hashtag in all social media messages they generate that relate to the event. Accordingly, other users can search for the messages using the hashtag.

Use of hashtags facilitates the identification of trends in social media. For instance, when the frequency of use of a hashtag over a set time period exceeds a given threshold, the hashtag can be identified as trending because a large number of users are likely posting messages that relate to the hashtag. Trending hashtags can signify, for example, recent events, currently popular topics, large gatherings, etc., and many organizations and individuals can benefit by knowing topics that are currently trending.

However, based simply on a frequency analysis, an identification of what is trending can only be made after a topic is popular. Accordingly, there is a desire for methods, systems, and computer readable media for earlier prediction of social media trends.

### SUMMARY

The present disclosure relates to systems, devices, and methods for predicting social media trends.

Implementations of the present teachings relate to methods, systems, and computer-readable storage media for predicting social media trends by receiving multiple sets of social media data from a social media service, wherein each set of social media data includes multiple entries and each entry is associated with a user identifier. For each set of social media data: labels can be extracted; a social media data graph can be generated with nodes representing labels and user identifiers and edges representing a co-occurrence of labels or a label and a user identifier; and the social media data graph can be analyzed to determine a graph metric score for nodes corresponding to a label. The graph metric scores of a node across multiple sets of social media data can be used to predict that the label corresponding to the node will begin trending.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a flow diagram illustrating an example of a method of predicting social media trends, consistent with certain disclosed embodiments;

FIG. 2A is a diagram depicting examples of labels extracted from social media data, consistent with certain disclosed embodiments;

FIG. 2B is a diagram depicting an example of a graph generated from social media data, consistent with certain disclosed embodiments;

FIG. 3A is a diagram depicting examples of graphs depicting frequency over time of nodes within an N-hop neighborhood of a selected node and centrality scores over time of the selected node, consistent with certain disclosed embodiments;

FIG. 3B is a diagram depicting examples of graphs depicting frequency over time of nodes within an N-hop neighborhood of a selected node and centrality scores over time of the selected node, consistent with certain disclosed embodiments;

FIG. 4 is a diagram depicting a schematic of a social media environment with social media trend prediction, consistent with certain disclosed embodiments; and

FIG. 5 is a diagram illustrating an example of a hardware system 500 for predicting social media trends, consistent with certain disclosed embodiments.

### DETAILED DESCRIPTION

The following detailed description refers to the accompanying drawings. Wherever convenient, the same reference numbers are used in the drawings and the following description refers to the same or similar parts. While several examples of embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

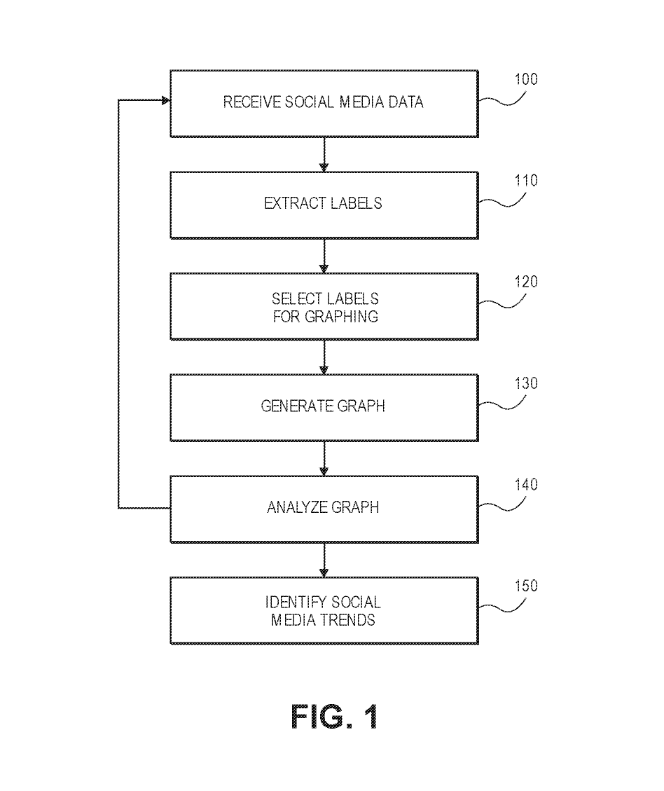

FIG. 1 is a flow diagram illustrating an example of a method of predicting social media trends, consistent with certain disclosed embodiments. The method can be performed on a computing device, such as, for example, a client device or a trend prediction server. In some implementations, a client device can be, for example, a personal computer, a mobile device, a tablet computer, or any other device with a network connection capable of receiving social media data.

In some embodiments, a trend prediction server can be networked server that is designed to access and analyze social media data. The trend prediction server can be connected directly or indirectly (e.g., via the Internet) to a social media server and/or database and receive social media data from the server/database, generate graphs based on the social media data, and/or analyze the graphs to predict social media trends, as discussed further below.

The example of a method shown can begin in 100, when the computing device receives social media data. In some implementations, the social media data may be received from an application programming interface (“API”). Various social media services provide a public API that allows public access to social media data via the API. In some embodiments, the API can stream live data to a requestor (e.g. a requestor's computing device implementing the method of FIG. 1) as it is being uploaded by users to the social media service's website. In other embodiments, the API can allow access to batches of data upon request.

In either embodiment, the computing device, prior to receiving the social media data, can request specified amounts, types, characteristics, etc. of social media data via a public API, such as a request to access: a specified amount of throughput (e.g., 1% of all currently streaming data), a specified date and time range of social media data, social media data pertaining to a specified subject matter, social media data containing a specific label, social media data from a specified geography location, a specified batch size, specified media types (e.g., text, video, images, etc.), etc. Based on the request, the computing device can receive the social media data.

In some embodiments, the social media data can be received as textual data separated into individual entries with each entry associated with a user identifier (e.g., a user name). In further embodiments, the social media data can include a combination of textual data, image data, and/or video data. In some implementations, the image data and video data may include metadata that is descriptive of the content of the image/video data. In further implementations, the social media data may include geographic locations of users that created the individual entries.

In 110, the computing device can extract labels from the received social media data. In some embodiments, the computing device can identify hashtags in the social media data to use as labels by searching for the hash symbol in each string corresponding to an individual entry and then tokenizing the entire word until a space occurs. Each hashtag in an entry can be extracted as an individual label and then associated with the entry, associated with other labels that co-occurred in the entry, associated with a geographic location of a user, and/or associated with a user identifier of the entry.

In further embodiments, the computing device can extract labels by tokenizing entries based on string or lexical patterns within each entry. For example, recognized words and/or phrases can be identified, tokenized, and extracted as individual labels and then associated with the entry, associated with other labels co-occurring in the entry, and/or associated with a user identifier of the entry. As an additional example, a string pattern can be a Uniform Resource Locator (“URL”) that is identified, tokenized, and extracted as an individual label, associated with the entry, associated with other labels co-occurring in the entry, associated with a geographic location of a user, and/or associated with a user identifier of the entry.

For example, there can be multiple hashtags all pertaining to events at a particular location (e.g., Washington, D.C.): #WASHINGTONMARCH #CLIMATEMARCHWASHINGTON #AUGUST5WASHINGTONMARCH #SUPPORTWASHINGTONMARCH, etc. The multiple hashtags can be recognized, resolved, and/or extracted as a label (e.g., #WASHINGTON). Thus, multiple different hashtags can have the same label extracted.

In other embodiments, the computing device can alternatively or additionally identify labels using metadata associated with image data or video data in the entries. The metadata can be used in whole or tokenized similar to textual data in the entries, extracted as individual labels, associated with the entry, associated with other labels co-occurring in the entry, associated with a geographic location of a user, and/or associated with a user identifier of the entry.

In 120, the computing device can select labels for generating a graph. In some embodiments where the labels are all hashtags, the computing device can select all the hashtags to graph. In other embodiments, the computing device can select a subset of the hashtags. For example, the computing device can select hashtags that meet certain criteria, such as hashtags that are within a specified length range, use words in a specified language, etc. In additional embodiments, the computing device can select all unique labels that were extracted in 110.

In further embodiments where labels include both hashtags and non-hashtag labels, the computing device can, for example, select all the hashtag labels and not select the non-hashtag labels, select a combination of both hashtag labels and non-hashtag labels, select all labels, select all labels that meet certain criteria, etc.

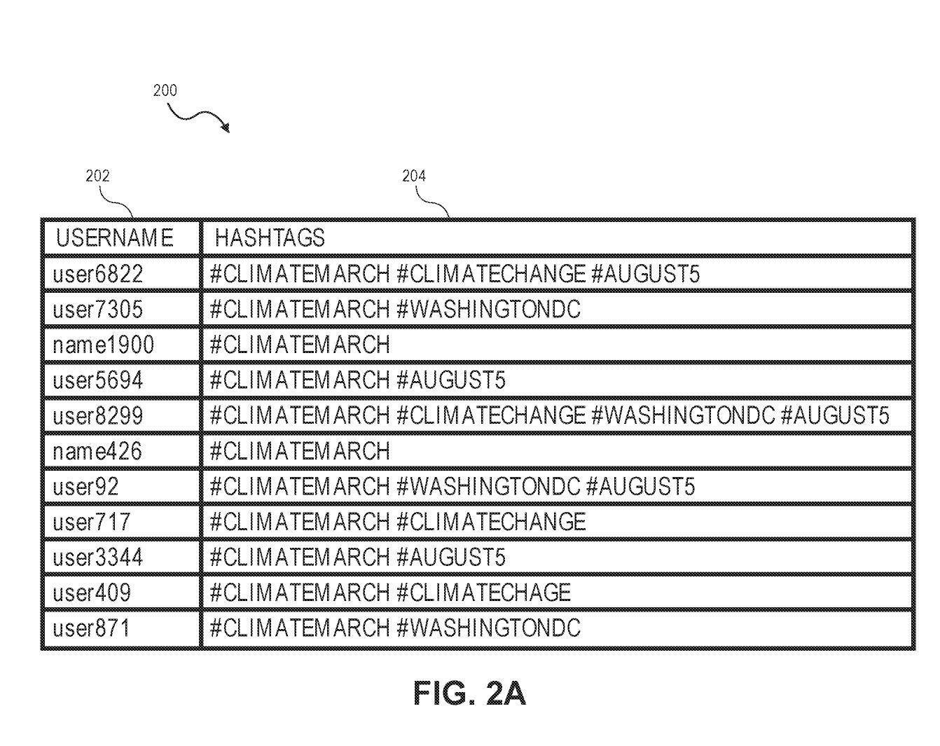

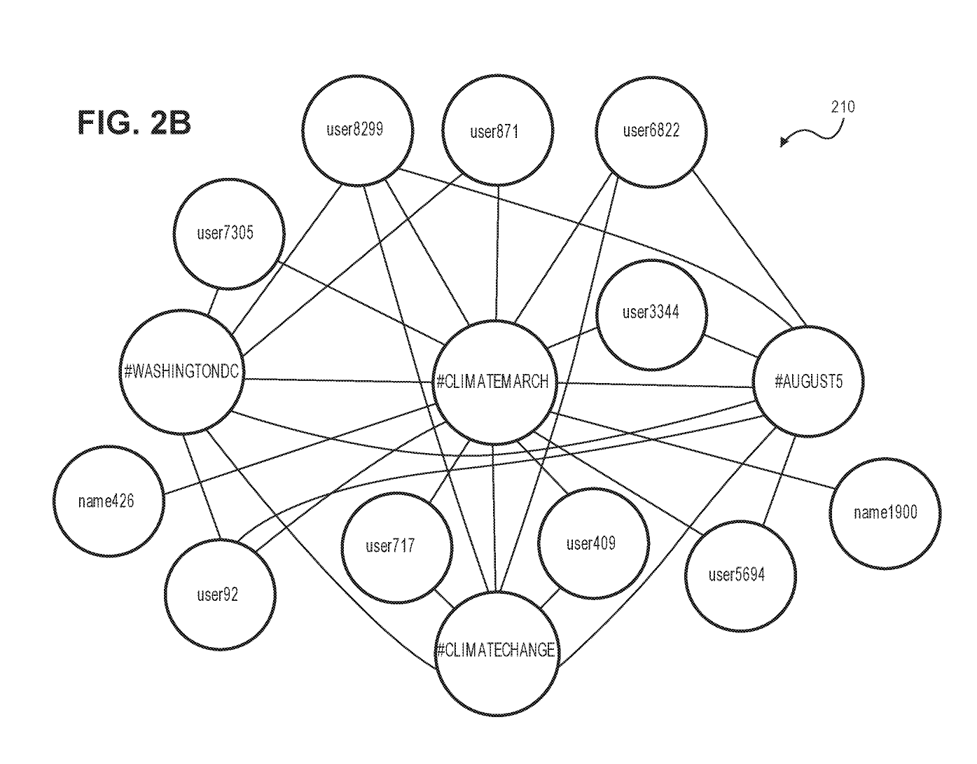

In 130, the computing device can generate a social media data graph using the selected labels from 120. In some embodiments, the computing device can generate an undirected graph of unordered nodes (also known as vertices) and edges. In other words, each node can identify connected edges with no indication of direction of the edges and/or each edge can identify connected nodes with no indication of an order of the nodes. An example of a visual representation of an undirected graph is shown in FIG. 2B.

In various implementations, each label and each user identifier can be represented as a node of the graph and an edge can represent a co-occurrence, in a single entry, of two labels or a label and a user identifier. In such implementations, a node can be a data structure or a representation of data that identifies a label or a user identifier. A node can also identify (e.g., include data representing) connected edges, co-occurrences with other nodes (e.g., an edge), a geographic location of a user, user accounts connected to the user (i.e., social media “friends” of the user), etc. As also used herein, an edge can be a data structure or a representation of data that indicates a co-occurrence of nodes. The edge may identify connected nodes, identify labels or user identifiers corresponding to the connected nodes, identify (e.g., include data representing) a geographic location of a user, etc.

For example, an entry in the social media data can be associated with a user identifier and include two hashtags that were extracted and selected as labels in 110 and 120. Each hashtag can be represented as a node and the user identifier can be represented as a node. Accordingly, three node data structures can be created and the node data structures can include or contain strings representing the respective hashtag or user identifier. Undirected edges, indicating co-occurrence in a single entry, can connect the two hashtags nodes to each other and each hashtag node to the user identifier node. Accordingly, three edge data structures can be created and the edges data structures can include or contain identifiers of the two nodes they connect (i.e., hashtag one and hashtag two, hashtag one and user identifier, and hashtag two and user identifier in this example). If, to further the example, a second entry in the social media data is associated with a second user identifier and includes hashtag one, a new node data structure can be created for the second user identifier, the hashtag node data structure would already exist for hashtag one. A new edge data structure would be created that includes identifiers of the nodes it connects (i.e., the second user identifier and the hashtag one).

In 140, the computing device can analyze the graph generated in 130. In various embodiments, conventional graph analytic functions that can be performed on the graph include, but are not limited to, betweenness centrality, Hyperlink-Induced Topic Search (“HITS”), eigenvector centrality, closeness centrality, and Katz centrality. For example, the computing device can perform the above functions as well as additional graph analytic functions that are built into the Stanford Network Analysis Platform (“SNAP”).

In some embodiments, the result of the graph analytic functions can be a graph metric score for each node. For example, a betweenness centrality score can be generated for each node. The betweenness centrality score is generally an indicator of the node's centrality in the graph, and is a function of the total number of shortest paths between nodes and the number of those paths that pass through the node being scored.

In various embodiments, the computing device can repeat 100-140 to obtain a series of scores for the nodes. For example, the computing device can repeat 100-140 on a first set of social media data that represents 1% of social media data at a particular social media website for a set period of time (e.g., one hour). The computing device can then repeat 100-140 for each subsequent set of social media data for each subsequent time period (e.g., one set of social media data per hour). Each node can be scored in each iteration, creating a time-varying graph metric for nodes corresponding to labels that are extracted from multiple sets of social media data.

In additional embodiments, further information can be monitored for the graph across the sets of social media data. For example, one or more nodes can be selected to be monitored by a user and components of an N-hop neighborhood for the selected nodes can be monitored over time. The user can select the node by inputting a search string and nodes corresponding to labels that match all or part of the search string can be selected.

An N-hop neighborhood includes all nodes that are within N hops of a selected node. Accordingly, a 2-hop neighborhood of a selected node includes all nodes that are directly connected to the selected node and all nodes that are connected to an intermediate node that is directly connected to the selected node. An N-hop neighborhood can be used, for example, to identify hashtags that could be contextually related to a selected node. For example, social media entries pertaining to an event frequently include occurrences of a date, a mission, and/or a location associated with the event as part of the text or as hashtags. Accordingly, the date, mission, and/or location can be extracted as labels from the entry and potentially identified as within an N-hop neighborhood of a label corresponding to the event.

In 150, the computing device can identify social media trends using the graph metric scores from 140. In some embodiments, the computing device can analyze the scores (e.g., the betweenness centrality scores) for the nodes to determine that an item represented by a node (e.g., a username, a hashtag, or a non-hashtag label) has trending significance (e.g., is likely to trend, will soon trend, is beginning to trend, is trending, etc.). In various embodiments, each node can have a series of time-varying scores, with a score for each time-separated iteration of 100-140.

In some implementations, the computing device can identify any anomalies in the series of scores for each node, such as, for example, a rapid increase in the score, and then designate, assign, or classify nodes having anomalies as having trending significance (e.g., is likely to trend, will soon trend, is beginning to trend, is trending, etc.). Another example of an anomalous rapid increase in score can be defined as a score that is a preset threshold number greater than a previous score. In another example, an average score can be determined for the entire series of scores, and an anomalous rapid increase in score can be defined as a score that is greater than a preset standard deviation from the average. As an additional example, an average score can be determined for a set of scores within a time window (e.g., five days), and an anomalous rapid increase in a score can be defined as a score within the time window that is greater than a preset standard deviation from the time window average. As a further example, an anomalous rapid increase in score can be defined as a score that is a preset percentage greater than a previous score (e.g., 100% greater).

In some embodiments, the computing device can additionally or alternatively use the N-hop neighborhood of a selected node to identify social media trends. For example, the computing device can track the number of entities observed over the N-hop neighborhood of the selected node as time-series data, and can detect a sudden and sustained growth in the size of the N-hop neighborhood (e.g., detected using a graph of the time-series data) that can indicate that a label associated with the selected node is beginning to trend.

As noted above, in some embodiments, an anomalous rapid increase in score of a label node is interpreted to indicate that the label is beginning to trend, is trending, or will soon begin to trend. For example, a rapid increase in betweenness centrality scores for a hashtag suggests or is interpreted to mean that the hashtag will soon begin trending because it implies that the hashtag is often on the shortest paths between users. The label node's increased betweenness centrality can be viewed as a reduction in the N-Hop distance between two unrelated users. When a user node has an edge that connects the user node to the label node (e.g., user uses a hashtag in his or her status update), the label is getting more visibility (e.g., the user's social media friends receive a status update associated with the user and the label). Thus, the more rapid the increase in user nodes that have a label node in the shortest path to other user nodes, the more the likelihood that the hashtag will begin trending.

In some embodiments, a number of social media friends of a user associated with a user node can also be used as a factor in identifying social media trends. For example, the computing device can monitor the number of friends that users within a 2-hop or 3-hop distance of a selected label node have. The more friends the users have, the more likely that the label will begin trending. Further, a lesser growth rate or negative growth rate of the betweenness centrality of the label node and/or in the number of friends of users who are within a given N-hop distance of the label node can indicate that the hashtag will soon no longer be trending.

In some implementations, an indication that a label is beginning to trend, etc., may also depend on the geographic locations of users associated with the social media data and/or geographic locations associated with a label. In some embodiments, entries in the social media data are associated with geographic locations of users that post the entries. Accordingly, the geographic locations of the users can be extracted from the entries. In further embodiments, certain labels indicate a geographic location. For example, an individual entry from the social media data can contain two hashtags, with one hashtag representing an event and one hashtag representing a geographic location of the event. Accordingly, both hashtags can be extracted as labels, and the node for the geographic location label would be within an N-hop neighborhood (a 1-hop neighborhood in this example) of the node for the event label.

In various embodiments, the geographic location associated with the users and/or geographic locations extracted by analyzing N-hop neighborhoods of a node can be used to determine geographic areas of where a label is trending, will soon begin to trend, etc. For example, a minor local event may cause a rapid increase in score of a label node associated with the minor local event. However, because the majority of the entries that include the label are associated with a small geographic area, the label may be beginning to trend locally, and would not be relevant to those monitoring global trends. According, in some embodiments, a requirement can be made that a rapid increase in score for a label node must correspond to varied geographic regions before the method designates that the label is beginning to widely, nationally, and/or globally trend is indicated.

In some implementations, the computing device can determine that a label is beginning to tend locally (i.e., beginning to trend in a smaller geographic region) when user nodes within an N-hop distance of a label node are also within an N-hop distance of the same or similar geographic information, such as, for example, latitude and longitude information, geographic labels, etc. Accordingly, a high centrality score of a label node that results in two unrelated users from the same geographic region falling within an N-hop distance from one another can indicate the label is beginning to trend in that geographic region.

In further implementations, the computing device can determine that a label is beginning to trend globally by determining that most users within an N-hop distance of the label node are spread throughout multiple countries.

In some embodiments, certain labels can be selected for monitoring. For example, a user can select labels by inputting a search string and nodes corresponding to labels that match all or part of the search string can be selected. In such embodiments, the user can be alerted if one or more of the selected labels begin to trend (e.g., locally, nationally, or globally), can be provided with labels corresponding to nodes within an N-hop neighborhood of the selected nodes, and/or can be alerted if one or more labels corresponding to nodes in the N-hop neighborhood of the selected nodes begin to trend. Such alerts can used to provide early indications and/or warnings of emergencies or other events. For example, alerts can be used by the Centers for Disease Control and Prevention to identify the potential onset of a disease in a geographic region, alerts can be used by police departments to identify potentially dangerous events, etc. Accordingly, by being provided early warnings, people or organizations can set up precautionary measures to prevent potentially dangerous situations and/or respond to dangerous situations before they escalate and become unmanageable.

While the operations depicted in FIG. 1 have been described as performed in a particular order, the order described is merely exemplary, and various different sequences of operations can be performed, consistent with certain disclosed embodiments. Additionally, the operations are described as discrete steps merely for the purpose of explanation, and, in some embodiments, multiple operations may be performed simultaneously and/or as part of a single computation. Further, the operations described are not intended to be exhaustive or absolute, and various operations can be inserted or removed.

FIG. 2A is a diagram depicting examples of labels extracted from social media data, consistent with certain disclosed embodiments. In particular, FIG. 2 depicts a table 200 that includes eleven entries. Each entry represents an entry in the social media data that includes the hashtag #CLIMATEMARCH. The social media data can, for example, represent all entries that include the hashtag from a percentage (e.g., 1%) of throughput from a particular social media service for a set period of time (e.g., one hour). The labels can be used to generate a single graph metric score for a #CLIMATEMARCH node (e.g., as described in 140).

Table 200 includes two columns 202 and 204. Each entry in column 202 represents the username (i.e., user identifier) associated with a single social media post and a single entry in a set of social media data. The username can represent an account that posted the social media content on a social media website of the social media service. Each username can be stored as, for example, a node data structure (e.g., as described in 130).

Each entry in column 204 represents the hashtags (i.e., labels) associated with a single social media post and a single entry in a set of social media data. The hashtags can be tokenized by searching for the hash symbol in the text of a single social media post and extracting text between the hash symbol and a space. As shown in column 220, several entries include multiple hashtags, indicating that the hashtags co-occurred in a single social media post. Each hashtag can be stored as, for example, a node data structure (e.g., as described in 130).

While table 200 shows an example of labels and user identifiers that can be extracted from social media data, such architecture and information is merely exemplary and different storage types and methods may be used, different label types may be used, and additional information may be used, as is consistent with disclosed embodiments.

FIG. 2B is a diagram depicting an example of a graph generated from social media data, consistent with certain disclosed embodiments. In particular, FIG. 2B depicts a graph 210 that includes fifteen unordered nodes and undirected edges that connect the nodes. Each node represents either a hashtag or a username from table 200 and an edge indicates that the corresponding hashtags of the two connected nodes co-occurred in the same entry (i.e., co-occurred in at least one social media post) or that a hashtag corresponding to a node was included in an entry associated with the username corresponding to the connected node. For example, the username user6822 is connected to the hashtags #CLIMATEMARCH, #CLIMATECHANGE, and #AUGUST5. Accordingly, the three hashtags co-occurred in a single social media post associated with the username user6899, as similarly shown in row two of table 200.

Graph 210 can be generated based on the information in table 200 (e.g., as described in 130). Graph 210 can be used to generate a single score for the #CLIMATEMARCH node (e.g., as described in 140).

While graph 210 shows examples of nodes and edges that can be generated from social media data, such architecture and information is merely exemplary, and a visual representation of the nodes and edges may not be generated. Further, different presentation styles, graph styles and graphing methods may be used, different label types may be graphed, and additional information may be graphed, as is consistent with disclosed embodiments.

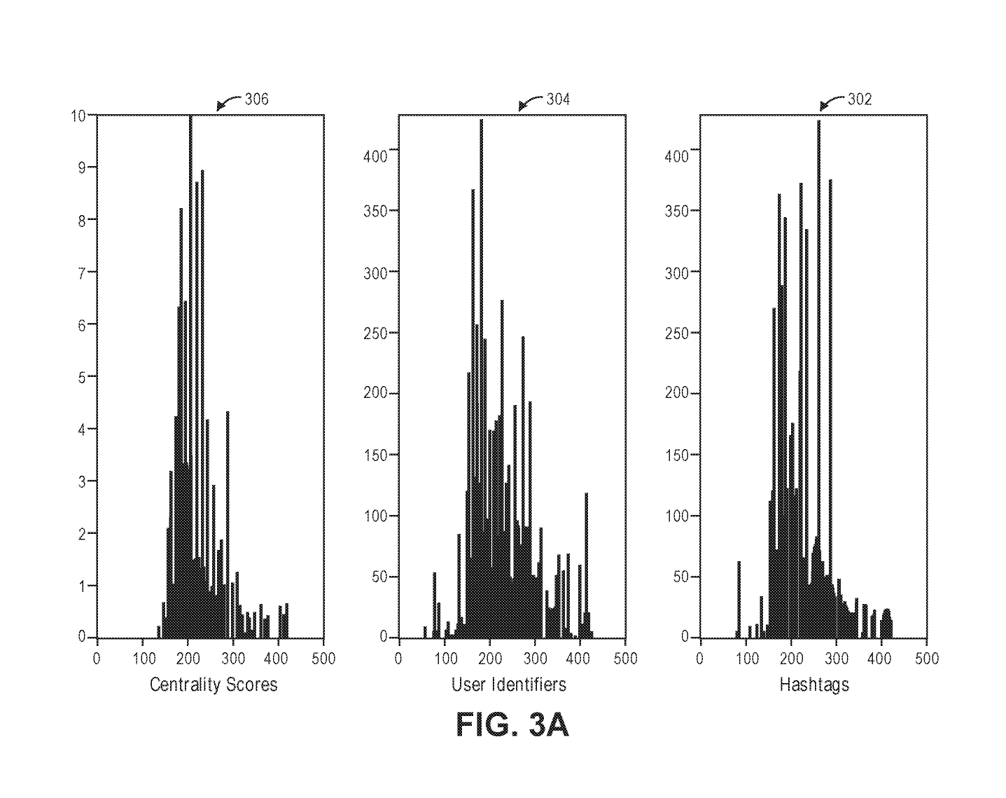

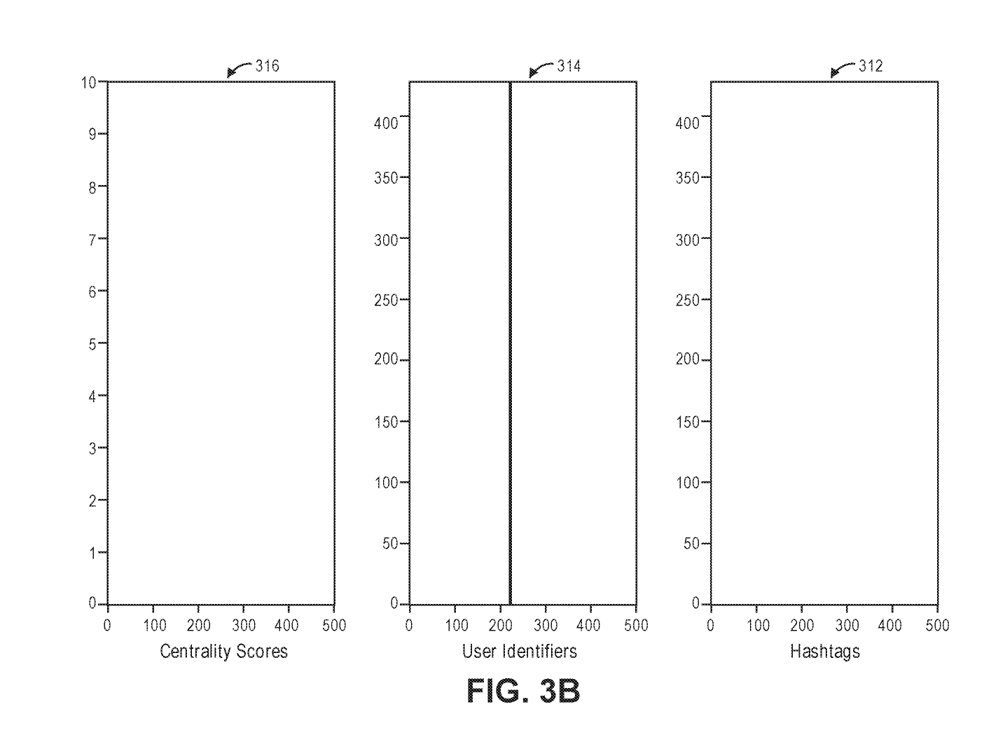

FIG. 3A is a diagram depicting examples of a graphs depicting frequency over time of nodes within an N-hop neighborhood of a selected node and centrality scores over time of the selected node, consistent with certain disclosed embodiments. In particular, FIG. 3A depicts frequency over time of nodes within an N-hop neighborhood (graphs 302 and 304), and centrality score over time graph 306. Graphs 302, 304, and 306 can represent data for a node that was selected because it corresponds to a selected label, such as a hashtag.

Graph 302 represents the frequency of hashtag nodes within an N-hop neighborhood of the selected node. Graph 304 represents the frequency of user identifier nodes within an N-hop neighborhood of the selected node. For example, the N-hop neighborhood can be a 2-hop neighborhood, where a frequency of nodes within two hops of the selected node is calculated for each time period. The y-axis of graph 302 and the y-axis of graph 304 represent the frequency, and the x-axis of graph 302 and the x-axis of graph 304 represent time. Each line in the graph can represent a single batch of data. For example, a batch can represent an iteration of 100-140, as shown in FIG. 1. Each iteration can be performed at regular timed intervals, such as every six hours. In other words, each iteration can represent a sample of social media data for a six-hour period and each iteration can represent a unit of time on graphs 302 and 304. Accordingly, time 1 could represent the first six-hour sample of social media data (e.g., 12:01 AM-6:00 AM, Day 1), time 2 could represent the second six-hour sample of social media data (e.g., 6:01 AM-12:00 PM, Day 1), etc.

Graph 306 represents centrality scores of the selected node. For example, the centrality score can be a betweenness centrality score. The y-axis of graph 306 represents the centrality score and the x-axis of graph 306 represents time. Each line in the graph can represent a single batch of data. For example, a batch can represent an iteration of 100-140, as shown in FIG. 1. The time intervals shown in graph 306 can represent the same time intervals shown in graphs 302 and 304. Accordingly, time 1 would represent the same sample of social media data (e.g., 12:01 AM-6:00 AM, Day 1) for each graph, etc.

Graph 306 shows that around time 200 an increase in the centrality score occurred. In some embodiments, as described in 150, the increase could be identified as a rapid increase in centrality score, indicating that the selected label is trending. Notably, the increase in the centrality score occurs at around the same time as similar increases in the frequency of user identifier nodes within a 2-hop neighborhood of the selected node and during a period where the frequency is above average for the entire set of data (graph 304). Additionally, the increase in the centrality score occurs around the same time period as similar increases in the frequency of hashtag nodes within a 2-hop neighborhood of the selected node (graph 302).

While graphs 302, 304, and 306 show examples of graphs that could be generated from social media data, such architecture and information is merely exemplary, and a visual representation of N-hop neighborhood frequencies and centrality scores may not be generated. Additionally, the frequencies, time units, and centrality scores are merely for the purpose of illustration and are not intended to depict actual values that are expected to occur and/or be determined. Further, different presentation styles, graph styles and graphing methods may be used, different label types may be graphed, and additional information may be graphed, as is consistent with disclosed embodiments.

FIG. 3B is a diagram depicting examples of a graphs depicting frequency over time of nodes within an N-hop neighborhood of a selected node and centrality scores over time of the selected node, consistent with certain disclosed embodiments. In particular, FIG. 3B depicts frequency over time of nodes within an N-hop neighborhood (graphs 312 and 314), and centrality score over time (graph 316). Graphs 312, 314, and 316 can represent data for a node that was selected because it corresponds to a selected label, such as a hashtag.

Graph 312 represents the frequency of hashtag nodes within an N-hop neighborhood of the selected node. Graph 314 represents the frequency of user identifier nodes within an N-hop neighborhood of the selected node. For example, the N-hop neighborhood can be a 2-hop neighborhood, where a frequency of nodes within two hops of the selected node is calculated for each time period. The y-axis of graph 312 and the y-axis of graph 314 represent the frequency, and the x-axis of graph 312 and the x-axis of graph 314 represent time. Each line in the graph can represent a single batch of data. For example, a batch can represent an iteration of 100-140, as shown in FIG. 1. Each iteration can be performed at regular timed intervals, such as every six hours. In other words, each iteration can represent a sample of social media data for a six-hour period and each iteration can represent a unit of time on graphs 312 and 314. Accordingly, time 1 could represent the first six-hour sample of social media data (e.g., 12:01 AM-6:00 AM, Day 1), time 2 could represent the second six-hour sample of social media data (e.g., 6:01 AM-12:00 PM, Day 1), etc.

Graph 316 represents centrality scores of the selected node. For example, the centrality score can be a betweenness centrality score. The y-axis of graph 316 represents the centrality score and the x-axis of graph 316 represents time. Each line in the graph can represent a single batch of data. For example, a batch can represent an iteration of 100-140, as shown in FIG. 1. The time intervals shown in graph 316 can represent the same time intervals shown in graphs 312 and 314. Accordingly, time 1 would represent the same sample of social media data (e.g., 12:01 AM-6:00 AM, Day 1) for each graph, etc.

Graph 314 shows between time 200 and time 300 an increase in the frequency of user name nodes within a 2-hop neighborhood of the selected hashtag node increases from negligible to beyond the scale of the graph. Such a result could indicate that the selected hashtag was used in a large number of social media posts during one time interval. However, the increase in graph 314 does not correspond to a similar increase in graph 312, which could indicate that although a large number of social media posts included the hashtag, those social media posts only used a single hashtag (the selected hashtag) and did not include other hashtags in the same post. Additionally, the increase in graph 314 did not correspond to a similar increase in graph 316. In some embodiments, as described in 150, the lack of an increase could represent that no rapid increase in centrality score was identified for the selected hashtag, indicating that the selected hashtag that corresponds to the graphs is not trending, will not continue to trend, and/or will not begin trending despite the increase in the frequency of user names.

For example, the lack of an increase could indicate that even though the number of user name nodes within a 2-hop distance of the selected hashtag node increased, other hashtags were gaining prominence at the same time and/or the selected hashtag did not have a requisite level of visibility to become trending. Generally, for a hashtag to become trending the topic needs both a strong promise of growth in user support (e.g., an increasing number of friends of users that have access to the topic leading to increased visibility) and the primary attention of a large number users (e.g., a lack of other issues of comparable weight).

While graphs 312, 314, and 316 show examples of graphs that could be generated from social media data, such architecture and information is merely exemplary, and a visual representation of N-hop neighborhood frequencies and centrality scores may not be generated. Additionally, the frequencies, time units, and centrality scores are merely for the purpose of illustration and are not intended to depict actual values that are expected to occur and/or be determined. Further, different presentation styles, graph styles and graphing methods may be used, different label types may be graphed, and additional information may be graphed, as is consistent with disclosed embodiments.

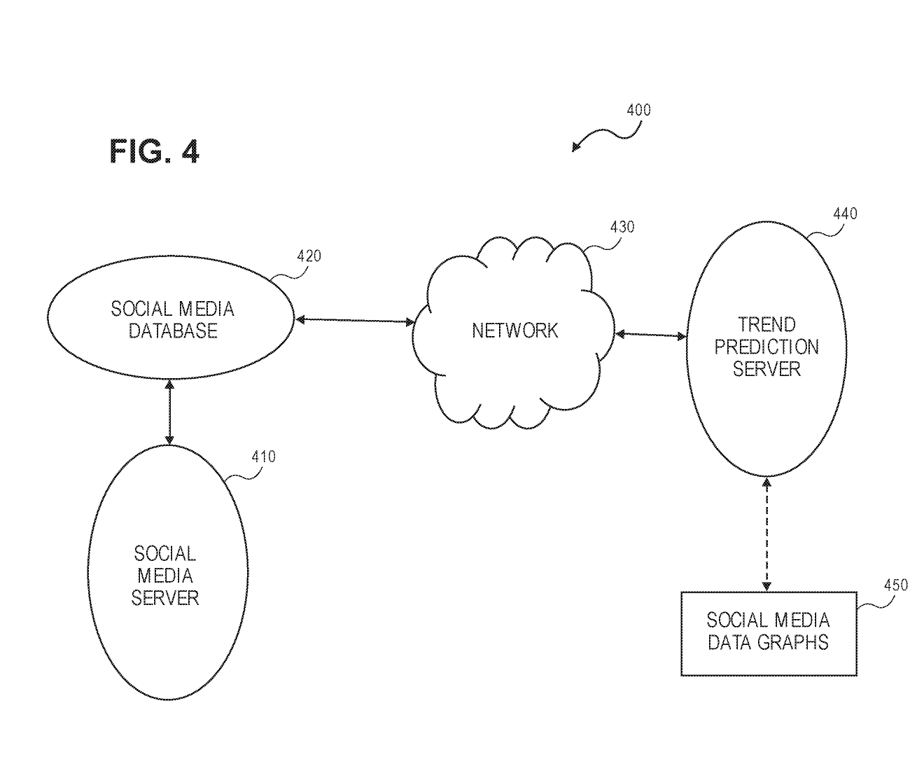

FIG. 4 is a diagram depicting a schematic of an example of a social media environment with social media trend prediction, consistent with certain disclosed embodiments. In particular, FIG. 4 depicts a social media environment 400, including a social media server 410, a social media database 420, a network 430, and a trend prediction server 440. Social media server 410 and trend prediction server 440 can be in communication with social media database 420, which may be implemented on its own server or computer, or on one of the other computing systems connected to the network 430. For example, social media server 410 and trend prediction server 440 can be in communication with social media database 420 via a direct connection or a network 430 (e.g., a local area network or a wide area network such as the Internet).

In some embodiments, social media server 410 can represent one or more computing devices that host and maintain a social media website. For example, social media server 410 can allow users, via client devices, to view and post social media content on the social media website. Additionally, social media server can access social media database 420 to store and retrieve social media content. In some embodiments, social media server 410 can be an application that runs on social media database 420 and is not a separate computing device.

In further embodiments, social media database 420 can represent one or more databases that store social media data, such as social media data provided via social media server 410. In some embodiments, social media database 420 can provide the social media data to social media server 410 and trend prediction server 440. For example, social media database 420 can provide a public API that allows public access to social media data via the API. In some embodiments, the API can stream live data as it is being uploaded by users to the social media website, which may in some embodiments be hosted by the social media server 410. In other embodiments, the API can allow access to batches of data upon request. The social media data can be publicly accessed by, for example, trend prediction server 440 via network 430 (e.g., the Internet). In some implementations, social media database 420 can be a database that is stored on social media server 410 and is not a separate computing or storage device.

In some implementations, trend prediction server 440 can represent one or more computing devices that request social media data, extract and select labels from the social media data (e.g., 110 and 120), generate and analyze social media data graphs 450 (e.g., 130 and 140), and predict and/or output social media trends (e.g., 150).

In some embodiments, trend prediction server 440 can be a separate server(s) or a separate client device(s), as depicted in FIG. 4. In such embodiments, trend prediction server 440 can receive social media data, either individually or as batches, from, for example, social media database 420 or social media server 410. In other embodiments, trend prediction server 440 can be an application that runs on, for example, social media database 420 or social media server 410, etc.

The example depicted in FIG. 4 is merely for the purpose of illustration, and is not intended to be limiting. For example, additional servers, computing devices, networks, and databases, may be used as part of a social media environment. Additionally, although social media data graphs 450 is depicted as separate from and connected to trend prediction server 440, social media data graphs 450 can be stored on remote devices or can be data stored on trend prediction server 440. Further, the social media environment depicted and processes described are merely a simplified example of a social media environment and social media trend prediction, consistent with certain disclosed embodiments, but such an example is not intended to be limiting.

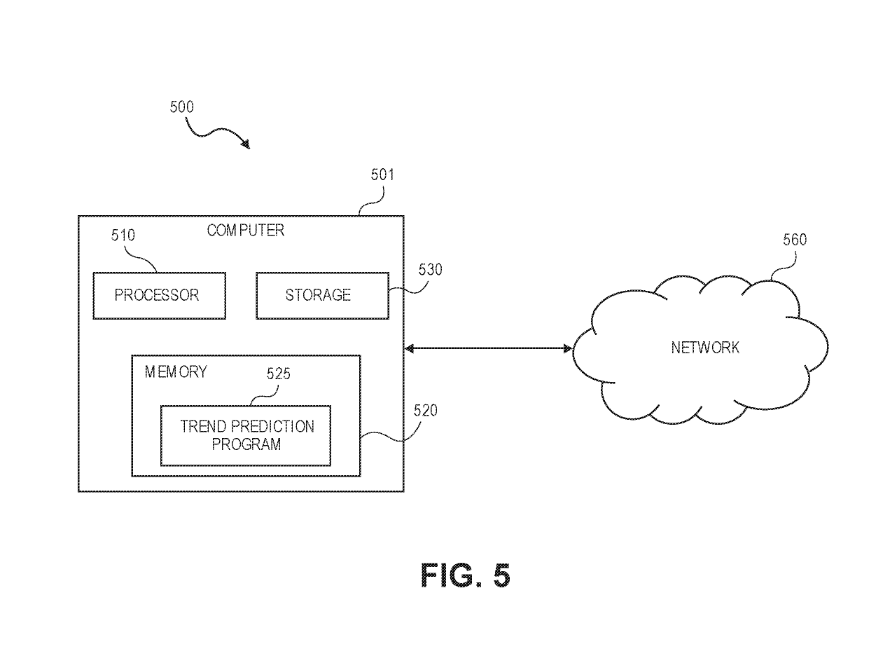

FIG. 5 is a diagram illustrating an example of a hardware system 500 for predicting social media trends, consistent with certain disclosed embodiments. The example system 500 includes example system components that may be used. The components and arrangement, however, may be varied.

A computer 501 may include a processor 510, a memory 520, storage 530, and input/output (I/O) devices (not pictured). The computer 501 may be implemented in various ways and can be configured to perform any of the embodiments described above. For example, the computer 501 may be a general purpose computer, a mainframe computer, any combination of these components, or any other appropriate computing device. The computer 501 may be standalone, or may be part of a subsystem, which may, in turn, be part of a larger system.

In some embodiments, the computer 501 can implement, for example, trend prediction server 440, as shown in FIG. 4 or the method of FIG. 1.

The processor 510 may include one or more known processing devices, such as a microprocessor from the Intel Core™ family manufactured by Intel™, the Phenom™ family manufactured by AMD™, or the like. Memory 520 may include one or more non-transitory storage devices configured to store information and/or instructions used by processor 510 to perform certain functions and operations related to the disclosed embodiments, such as the method of FIG. 1. Storage 530 may include a volatile, non-volatile, non-transitory, magnetic, semiconductor, tape, optical, removable, non-removable, or other type of computer-readable medium used as a storage device. In some embodiments, storage 530 can store social media data graphs 450 and the like.

In one embodiment, memory 520 may include one or more programs or subprograms including instructions that may be loaded from storage 530 or elsewhere that, when executed by computer 501, perform various procedures, operations, or processes consistent with disclosed embodiments. For example, memory 520 may include a trend prediction program 525 for requesting social media data, extracting and selecting labels from the social media data (e.g., 110 and 120), generating and analyzing social media data graphs 450 (e.g., 130 and 140), and predicting social media trends (e.g., 150) according to various disclosed embodiments. Memory 520 may also include other programs that perform other functions, operations, and processes, such as programs that provide communication support, Internet access, etc. The trend prediction program 525 may be embodied as a single program, or alternatively, may include multiple subprograms that, when executed, operate together to perform the functions and operations of the trend prediction program 525 according to disclosed embodiments. In some embodiments, trend prediction program can perform the process and operations of FIG. 1 described above.

The computer 501 may communicate over a link with a network 560. For example, the link may be a direct communication link, a local area network (LAN), a wide area network (WAN), or other suitable connection. The network 560 may include the Internet, as well as other networks, which may be connected to various systems and devices, such as network 430.

The computer 501 may include one or more input/output (I/O) devices (not pictured) that allow data to be received and/or transmitted by the computer 501. I/O devices may also include one or more digital and/or analog communication I/O devices that allow the computer 501 to communicate with other machines and devices. I/O devices may also include input devices such as a keyboard or a mouse, and may include output devices such as a display or a printer. The computer 501 may receive data from external machines and devices and output data to external machines and devices via I/O devices. The configuration and number of input and/or output devices incorporated in I/O devices may vary as appropriate for various embodiments.

Example uses of the system 500 can be described by way of example with reference to the example embodiments described above.

While the teachings has been described with reference to the example embodiments, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. Those skilled in the art will recognize that these and other variations are possible within the spirit and scope as defined in the following claims and their equivalents.

What is claimed is:

1. A computer-implemented method, comprising:
receiving a set of social media data comprising a plurality of entries, wherein each entry of the plurality of entries is associated with a user identifier;
extracting, using one or more processors, a plurality of labels from the set of social media data;
generating a social media data graph comprising a plurality of nodes and a plurality of edges, wherein:
each node of the plurality of nodes corresponds to one of a unique label of the plurality of labels or a user identifier associated with an entry of the plurality of entries; and
each edge of the plurality of edges corresponds to a co-occurrence, in a single entry of the plurality of entries, of two labels of the plurality of labels or a label of the plurality of labels and a user identifier;
determining a graph metric score of a node, of the plurality of nodes, corresponding to a label; and
predicting that the label will begin trending based on the graph metric score of the node corresponding to the label.

2. The computer-implemented method of claim 1, further comprising:
receiving a second set of social media data;
extracting a second plurality of labels from the second set of social media data, wherein the second plurality of labels includes the label;
generating a second social media data graph based on the second plurality of labels, wherein the second social media data graph comprises a second plurality of nodes and a second plurality of edges;
determining a second graph metric score of a node, of the second plurality of nodes, corresponding to the label; and
wherein predicting that the label will begin trending based on the graph metric score of the node corresponding to the label comprises determining that the second graph metric score is a threshold number greater than the graph metric score.

3. The computer-implemented method of claim 1, wherein predicting that the label will begin trending comprises predicting that the label will begin trending widely based on geographic locations of users associated with entries, of the plurality of entries, associated with the label.

4. The computer-implemented method of claim 3, further comprising:
alerting a user that the label will begin trending widely in response to the predicting.

5. The computer-implemented method of claim 1, further comprising:
receiving, from a user, a request to monitor the label;
alerting the user that the label will begin trending; and
wherein determining the graph metric score and predicting that the label will begin trending are performed in response to receiving the request.

6. The computer-implemented method of claim 1, further comprising:
receiving, from a user, a request to monitor a second label;
determining that the label is within a 2-hop neighborhood of the second label;
alerting the user that the label will begin trending; and
wherein determining the graph metric score and predicting that the label will begin trending are performed in response to determining that the label is within the 2-hop neighborhood of the second label.

7. The computer-implemented method of claim 1, further comprising:
receiving, from a user, a request for information about a second label;
determining a list of labels within a 2-hop neighborhood of the second label; and
providing the list of labels to the user.

8. A system comprising:
a processing system of a device comprising one or more processors; and
a memory system comprising one or more computer-readable media, wherein the one or more computer-readable media contain instructions that, when executed by the processing system, cause the processing system to perform operations comprising:
receiving a set of social media data comprising a plurality of entries, wherein each entry of the plurality of entries is associated with a user identifier;
extracting, using one or more processors, a plurality of labels from the set of social media data;
generating a social media data graph comprising a plurality of nodes and a plurality of edges, wherein:
each node of the plurality of nodes corresponds to one of a unique label of the plurality of labels or a user identifier associated with an entry of the plurality of entries; and
each edge of the plurality of edges corresponds to a co-occurrence, in a single entry of the plurality of entries, of two labels of the plurality of labels or a label of the plurality of labels and a user identifier;
determining a graph metric score of a node, of the plurality of nodes, corresponding to a label; and
predicting that the label will begin trending based on the graph metric score of the node corresponding to the label.

9. The system of claim 8, the operations further comprising:
receiving a second set of social media data;
extracting a second plurality of labels from the second set of social media data, wherein the second plurality of labels includes the label;
generating a second social media data graph based on the second plurality of labels, wherein the second social media data graph comprises a second plurality of nodes and a second plurality of edges;
determining a second graph metric score of a node, of the second plurality of nodes, corresponding to the label; and
wherein predicting that the label will begin trending based on the graph metric score of the node corresponding to the label comprises determining that the second graph metric score is a threshold number greater than the graph metric score.

10. The system of claim 8, wherein predicting that the label will begin trending comprises predicting that the label will begin trending widely based on geographic locations of users associated with entries, of the plurality of entries, associated with the label.

11. The system of claim 10, the operations further comprising:
alerting a user that the label will begin trending widely in response to the predicting.

12. The system of claim 8, the operations further comprising:
receiving, from a user, a request to monitor the label;
alerting the user that the label will begin trending; and
wherein determining the graph metric score and predicting that the label will begin trending are performed in response to receiving the request.

13. The system of claim 8, the operations further comprising:
receiving, from a user, a request to monitor a second label;
determining that the label is within a 2-hop neighborhood of the second label;
alerting the user that the label will begin trending; and
wherein determining the graph metric score and predicting that the label will begin trending are performed in response to determining that the label is within the 2-hop neighborhood of the second label.

14. The system of claim 8, the operations further comprising:
receiving, from a user, a request for information about a second label;
determining a list of labels within a 2-hop neighborhood of the second label; and
providing the list of labels to the user.

15. A non-transitory computer readable storage medium comprising instructions for causing one or more processors to:
receiving a set of social media data comprising a plurality of entries, wherein each entry of the plurality of entries is associated with a user identifier;
extracting, using one or more processors, a plurality of labels from the set of social media data;
generating a social media data graph comprising a plurality of nodes and a plurality of edges, wherein:
each node of the plurality of nodes corresponds to one of a unique label of the plurality of labels or a user identifier associated with an entry of the plurality of entries; and
each edge of the plurality of edges corresponds to a co-occurrence, in a single entry of the plurality of entries, of two labels of the plurality of labels or a label of the plurality of labels and a user identifier;
determining a graph metric score of a node, of the plurality of nodes, corresponding to a label; and
predicting that the label will begin trending based on the graph metric score of the node corresponding to the label.

16. The non-transitory computer readable storage medium of claim 15, the instructions further comprising:
receiving a second set of social media data;
extracting a second plurality of labels from the second set of social media data, wherein the second plurality of labels includes the label;
generating a second social media data graph based on the second plurality of labels, wherein the second social media data graph comprises a second plurality of nodes and a second plurality of edges;
determining a second graph metric score of a node, of the second plurality of nodes, corresponding to the label; and
wherein predicting that the label will begin trending based on the graph metric score of the node corresponding to the label comprises determining that the second graph metric score is a threshold number greater than the graph metric score.

17. The non-transitory computer readable storage medium of claim 15, wherein predicting that the label will begin trending comprises predicting that the label will begin trending widely based on geographic locations of users associated with entries, of the plurality of entries, associated with the label.

18. The non-transitory computer readable storage medium of claim 15, the instructions further comprising:
receiving, from a user, a request to monitor the label;
alerting the user that the label will begin trending; and
wherein determining the graph metric score and predicting that the label will begin trending are performed in response to receiving the request.

19. The non-transitory computer readable storage medium of claim 15, the instructions further comprising:
receiving, from a user, a request to monitor a second label;
determining that the label is within a 2-hop neighborhood of the second label;
alerting the user that the label will begin trending; and
wherein determining the graph metric score and predicting that the label will begin trending are performed in response to determining that the label is within the 2-hop neighborhood of the second label.

20. The non-transitory computer readable storage medium of claim 15, the instructions further comprising:
receiving, from a user, a request for information about a second label;
determining a list of labels within a 2-hop neighborhood of the second label; and
providing the list of labels to the user.
